(19) United States
(12) Patent Application Publication
(10) Pub. No.: US 2017/0100897 A1
(43) Pub. Date: Apr. 13, 2017

(54) THREE-DIMENSIONAL PRINTING DEVICE

(71) Applicants: XYZPRINTING, INC., NEW TAIPEI CITY (TW); KINPO ELECTRONICS, INC., NEW TAIPEI CITY (TW); CAL-COMP ELECTRONICS & COMMUNICATIONS COMPANY LIMITED, NEW TAIPEI CITY (TW)

(72) Inventors: HSIEN-CHUNG CHEN, NEW TAIPEI CITY (TW); TING-YU LU, NEW TAIPEI CITY (TW)

(21) Appl. No.: 14/920,629

(22) Filed: Oct. 22, 2015

(30) Foreign Application Priority Data
Oct. 13, 2015 (CN) 201510669043.3

(51) Int. Cl. B29C 67/00

(52) U.S. Cl. CPC B29C 67/0092; B33Y 30/00

(57) ABSTRACT

A three-dimensional printing device for solidifying and forming a forming liquid includes a forming tank, a pressure tank and a connecting line. The forming tank is for storing the forming liquid and the bottom of the forming tank protrudes towards the inside of the forming tank to form a forming area. The pressure tank is for providing a predetermined pressure. One end of the connecting line is connected to the pressure tank while the other end thereof is connected to the forming tank and is between a top surface of the forming area and the bottom of the forming tank. The pressure tank provides a predetermined pressure to the forming liquid to make the forming liquid submerge the forming area. Because of the pressure tank, it is able to precisely and stably maintain the depth of the liquid level of the forming liquid in the forming tank.

### BACKGROUND OF THE INVENTION

1. Technical Field

The disclosure relates to a three-dimensional printing device, more particularly to a three-dimensional printing device capable of maintaining the liquid level of the forming liquid therein.

2. Description of prior art

The conventional three-dimensional printing technology includes a variety of forming methods. One of the forming methods is conducted by ultraviolet irradiating photosensitive resin of liquid form to solidify the photosensitive resin. The three-dimensional printing device utilizing the forming method of solidifying the photosensitive resin generally comprises a tank, an ultraviolet light source, and a movable platform. The platform is immersed in the photosensitive resin, and then ultraviolet irradiates on the platform to solidify and form a thin layer of solid photosensitive resin on the platform. Subsequently, the platform is raised so the solid photosensitive resin is raised above the liquid level, and the process is repeated on the bottom of the solid photosensitive resin to form another layer of solid photosensitive resin. The aforementioned process is conducted multiple times to build a three-dimensional object, layer by layer.

Since the viscosity of the photosensitive resin is quite high, the resistance that the platform encounters during raising the semi-finished product of the three-dimensional object immersed in the photosensitive resin is also quite strong. This therefore affects its forming speed negatively.

Accordingly, the disclosure aims to provide an improved design to solve the problems mentioned above.

### SUMMARY OF THE INVENTION

The disclosure provides a three-dimensional printing device capable of maintaining the liquid level of the forming liquid therein.

The disclosure provides a three-dimensional printing device, configured for solidifying and forming a forming liquid, comprising a forming tank, a pressure tank and a connecting line. The forming tank is for storing the forming liquid and the bottom of the forming tank protrudes towards the inside of the forming tank to form a forming area. The pressure tank is for providing a predetermined pressure. One end of the connecting line is connected to the pressure tank while the other end of the connecting line is connected to the forming tank and is between a top surface of the forming area and the bottom of the forming tank. The pressure tank provides a predetermined pressure to the forming liquid to make the forming liquid submerge the forming area.

In one embodiment of the disclosure, the forming area is translucent and a lighting device is disposed below the forming area.

In one embodiment of the disclosure, the pressure tank stores the forming liquid. The pressure tank may be connected to an air compressor which is for generating the predetermined pressure. The pressure tanks may be connected to a liquid storage tank, and a liquid pump for generating the predetermined pressure is disposed between the pressure tank and the liquid storage tank.

In one embodiment of the disclosure, the forming tank may form an overflow wall and a top edge of the overflow wall goes beyond the forming area. The forming tank is connected to a liquid collection tank and the overflow wall is between and blocks the forming tank and the liquid collection tank. A pumping line may be between and connect the pressure tank and the liquid collection tank, and the pumping direction of the pumping line is towards the pressure tank.

Because of the pressure tank, the three-dimensional printing device of the disclosure is able to precisely and stably maintain the depth of the liquid level of the forming liquid in the forming tank.

### BRIEF DESCRIPTION OF THE DRAWINGS

The disclosure will become more fully understood from the detailed description and the drawings given herein below for illustration only, and thus does not limit the present disclosure, wherein:

FIG. 1 is a schematic view of a three-dimensional printing device according to the first embodiment of the disclosure;

FIG. 2 is a schematic view of a three-dimensional printing device according to the second embodiment of the disclosure; and

FIG. 3 is a schematic view of a three-dimensional printing device according to the third embodiment of the disclosure.

### DETAILED DESCRIPTION OF THE INVENTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

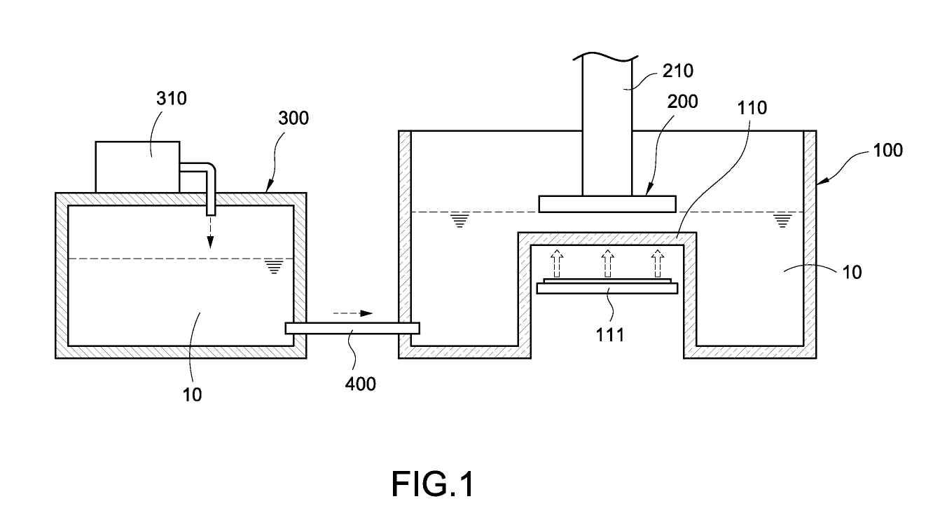

Referring to FIG. 1, a three-dimensional printing device according to the first embodiment of the disclosure comprises a forming tank 100, a forming platform 200, a pressure tank 300 and a connecting line 400.

The inside of the forming tank 100 is for storing a forming liquid 10. The bottom of the forming tank 100 protrudes towards the forming tank 100 and forms a forming area 110. The top surface of the forming area 110 is preferably a plane arranged horizontally. The forming liquid 10 is preferably photosensitive resin which can be solidified by ultraviolet irradiation and the depth of the forming liquid is sufficient to submerge the forming area 110. In this embodiment, the forming tank 100 is preferably made of translucent material. A lighting device 111 is disposed below the forming area 110 and is for generating ultraviolet light. The ultraviolet light penetrates the forming area 110 so that the forming liquid 10 between the top surface of the forming area 110 and the liquid level of the forming liquid 10 may be solidified.

The forming platform 200 is arranged above the forming area 110 and is preferably put into the forming tank 100 in an arrangement corresponding to the forming area 110. The forming platform 200 is connected to an actuator 210 to drive the forming platform 200 to move perpendicularly. At first, the forming platform 200 is in contact with the liquid level of the forming liquid 10. After the forming liquid 10 in contact with the forming platform 200 is solidified, the forming platform 200 is raised to pull the solidified forming liquid 10 out of the liquid level. The bottom of this partially solidified forming liquid 10 touches the liquid level of the forming liquid 10. Again, ultraviolet light irradiates the forming liquid 10 such that the forming liquid 10 is solidified and joined to the previous solidified forming liquid 10.

The pressure tank 300 is for providing a predetermined pressure. In this embodiment, the inside of the pressure tank 300 stores the forming liquid 10 while the pressure tank 300 is connected to a air compressor 310. The air compressor 310 compresses and injects air into the pressure tank 300 to maintain the predetermined pressure inside the pressure tank 300.

One end of the connecting line 400 is connected to the pressure tank 300 and the depth of this end is preferably in the pressure tank 300 and below the liquid level of the forming liquid 10. The other end of the connecting line 400 is connected to the forming tank 100 and the depth of this end is preferably between the top surface of the forming area 110 and the bottom of the forming tank 100, therefore below the liquid level of the forming liquid 10 in the forming tank 100.

In the three-dimensional printing device of the disclosure, the pressure tank 300 provides a predetermined pressure to the forming liquid 10 inside the forming tank 100. The liquid level of the forming liquid 10 in the forming tank 100, therefore, maintains at a fixed depth. When the forming liquid 10 in the forming tank 100 is solidified and consumed, the pressure of the forming liquid 10 in the forming tank 100 is lowered to make the forming liquid 10 in the forming tank 100 flow into the forming tank 100 through the connecting line 400, until the pressure of the forming liquid 10 in the forming tank 100 and the predetermined pressure are balanced where the forming liquid 10 in the connecting line 400 no longer flows. In contrast, when the forming liquid 10 in the forming tank 100 is excessive, the pressure of the forming liquid 10 in the forming tank 100 drives the forming liquid 10 in the forming tank 100 to flow into the pressure tank 300 via the connecting line 400, until the pressure of the forming liquid 10 in the forming tank 100 and the predetermined pressure are balanced where the forming liquid 10 in the connecting line 400 no longer flows. By the pressure tank 300, the three-dimensional printing device of the disclosure is able to precisely maintain the depth of the liquid level of the forming liquid 10, and therefore able to maintain a fixed small distance from the top surface of the forming area 110 (namely the thickness of the single solidified layer). As a result, the forming platform 200 or the solidified forming liquid 10 only contacts the liquid level of the forming liquid 10 in the liquid state, without the need to be immersed in the forming liquid 10 in the liquid state. This reduces the resistance of the forming platform 200 being raised up and thus improves the forming speed.

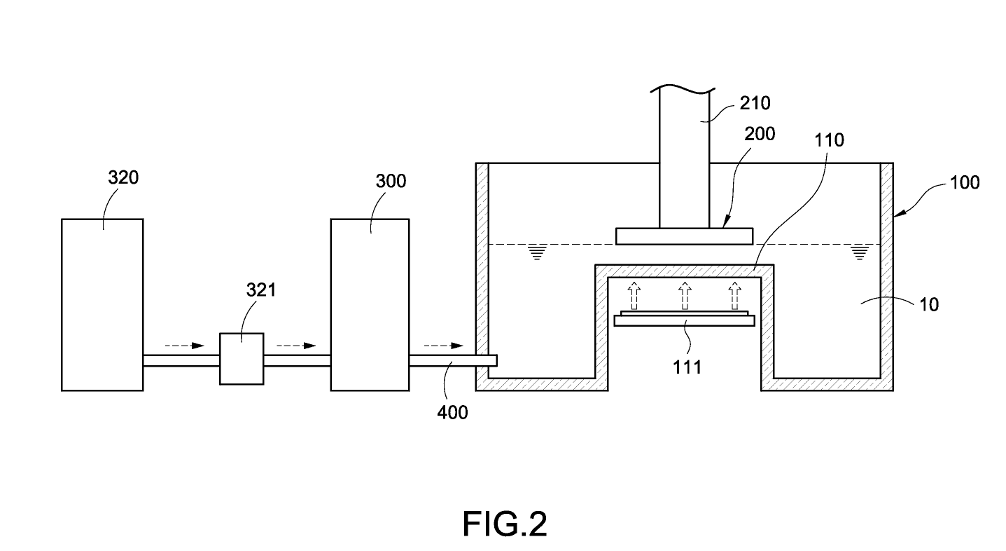

Referring to FIG. 2, a three-dimensional printing device according to the second embodiment of the disclosure comprises a forming tank 100, a forming platform 200, a pressure tank 300 and a connecting line 400.

The inside of the forming tank 100 is for storing a forming liquid 10. The bottom of the forming tank 100 protrudes towards the forming tank 100 and forms a forming area 110. The top surface of the forming area 110 is preferably a plane arranged horizontally. The forming liquid 10 is preferably photosensitive resin which can be solidified by ultraviolet irradiation and the depth of the forming liquid 10 is sufficient to submerge the forming area 110. In this embodiment, the forming tank 100 is preferably made of translucent material. A lighting device 111 is disposed below the forming area 110 and is for generating ultraviolet light. The ultraviolet light penetrates the forming area 110 so that the forming liquid 10 between the top surface of the forming area 110 and the liquid level of the forming liquid 10 may be solidified.

The forming platform 200 is arranged above the forming area 110 and is preferably put into the forming tank 100 in an arrangement corresponding to the forming area 110. The forming platform 200 is connected to an actuator 210 to drive the forming platform 200 to move perpendicularly. At first, the forming platform 200 is in contact with the liquid level of the forming liquid 10. After the forming liquid 10 in contact with the forming platform 200 is solidified, the forming platform 200 is raised to pull the solidified forming liquid 10 out of the liquid level. The bottom of this partially solidified forming liquid 10 touches the liquid level of the forming liquid 10. Again, ultraviolet light irradiates the forming liquid 10 such that the forming liquid 10 is solidified and joined to the previous solidified forming liquid 10.

The pressure tank 300 is for providing a predetermined pressure. In this embodiment, the pressure tank 300 is connected to a liquid storage tank 320. Both the pressure tank 300 and the liquid storage tank 320 store the forming liquid 10 while a liquid pump 321 is disposed between the pressure tank 300 and the liquid storage tank 320. The liquid pump 321 pumps the forming liquid 10 in the liquid storage tank 320 into the pressure tank 300 to maintain the predetermined pressure of the forming liquid 10 of the pressure tank 300.

One end of the connecting line 400 is connected to the pressure tank 300 and the depth of this end is preferably below the liquid level of the forming liquid 10 of the pressure tank 300. The other end of the connecting line 400 is connected to the forming tank 100 and the depth of is preferably between the top surface of the forming area 110 and the bottom of the forming tank 100, therefore below the liquid level of the forming liquid 10 in the forming tank 100.

When the forming liquid 10 in the forming tank 100 is solidified and consumed, the pressure of the forming liquid 10 in the forming tank 100 is lowered to make the forming liquid 10 in the forming tank 100 flow into the forming tank 100 through the connecting line 400, until the pressure of the forming liquid 10 in the forming tank 100 and the predetermined pressure are balanced where the forming liquid 10 in the connecting line 400 no longer flows. In contrast, when the forming liquid 10 in the forming tank 100 is excessive, the pressure of the forming liquid 10 in the forming tank 100 drives the forming liquid 10 in the forming tank 100 to flow into the pressure tank 300 via the connecting line 400, until the pressure of the forming liquid 10 in the forming tank 100 and the predetermined pressure are balanced where the forming liquid 10 in the connecting line 400 no longer flows. Because of the pressure tank 300, it is possible to precisely maintain the depth of the liquid level of the forming liquid 10, and therefore able to maintain a fixed small distance from the top surface of the forming area 110 (namely the thickness of the single solidified layer). As a result, the forming platform 200 or the solidified forming liquid 10 only contacts the liquid level of the forming liquid 10 in the liquid state, without the need to be immersed in the forming liquid 10 in the liquid state. This reduces the resistance of the forming platform 200 being raised up and thus improves the forming speed.

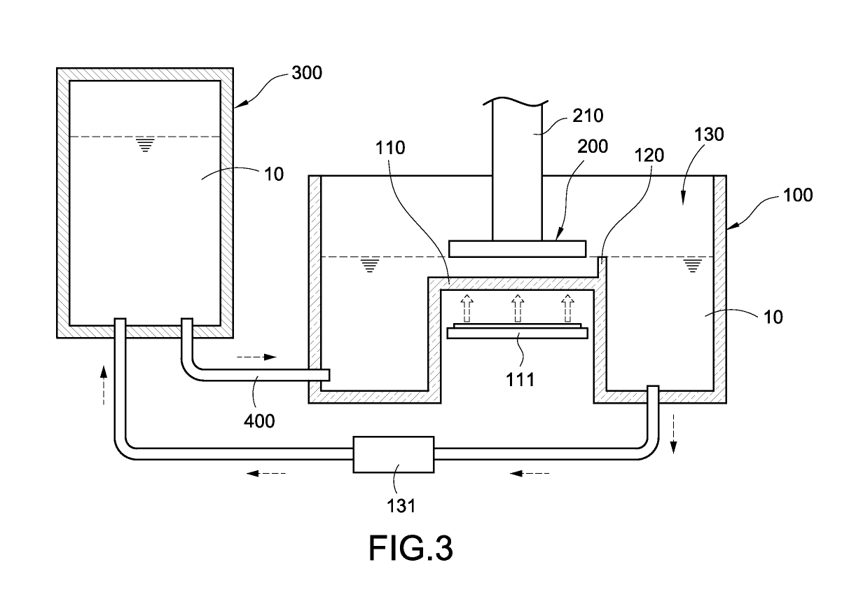

Referring to FIG. 3, a three-dimensional printing device according to the third embodiment of the disclosure comprises a forming tank 100, a forming platform 200, a pressure tank 300 and a connecting line 400.

The inside of the forming tank 100 is for storing a forming liquid 10. The bottom of the forming tank 100 protrudes towards the forming tank 100 and forms a forming area 110. The top surface of the forming area 110 is preferably a plane arranged horizontally. The forming tank 100 forms an overflow wall 120 and the top edge of the overflow wall 120 goes beyond the forming area 110. The forming tank 100 is connected to a liquid collection tank 130 and the overflow wall 120 is between and blocks the forming tank 100 and the liquid collection tank 130. A pumping line 131 is between and connects the pressure tank 300 and the liquid collection tank 130, and the pumping direction of the pumping line 131 is towards the pressure tank 300.

The forming liquid 10 is preferably photosensitive resin which can be solidified by ultraviolet irradiation and the depth of the forming liquid 10 is sufficient to submerge the forming area 110. In this embodiment, the forming tank 100 is preferably made of translucent material. A lighting device 111 is disposed below the forming area 110 and is for generating ultraviolet light. The ultraviolet light penetrates the forming area 110 so that the forming liquid 10 between the top surface of the forming area 110 and the liquid level of the forming liquid 10 may be solidified.

The forming platform 200 is arranged above the forming area 110 and is preferably put into the forming tank 100 in an arrangement corresponding to the forming area 110. The forming platform 200 is connected to an actuator 210 to drive the forming platform 200 to move perpendicularly. At first, the forming platform 200 is in contact with the liquid level of the forming liquid 10. After the forming liquid 10 in contact with the forming platform 200 is solidified, the forming platform 200 is raised to pull the solidified forming liquid 10 out of the liquid level. The bottom of this partially solidified forming liquid 10 touches the liquid level of the forming liquid 10. Again, ultraviolet light irradiates the forming liquid 10 such that the forming liquid 10 is solidified and joined to the previous solidified forming liquid 10.

The inside of the pressure tank 300 stores the forming liquid 10 and maintains a predetermined pressure. This makes a fixed amount of the forming liquid continuously flow into the forming tank 100. When the liquid level of the forming liquid 10 in the forming tank 100 goes beyond the overflow wall 120, the forming liquid 10 is discharged from the forming tank 100, over the overflow wall 120. Thereby, the liquid level of the forming liquid 10 in the forming tank 100 maintains at a fixed depth, and therefore it is able to maintain a fixed small distance from the top surface of the forming area 110 (namely the thickness of the single solidified layer). As a result, the forming platform 200 or the solidified forming liquid 10 only contacts the liquid level of the forming liquid 10 in the liquid state, without the need to be immersed in the forming liquid 10 in the liquid state. This reduces the resistance of the forming platform 200 being raised up and thus improves the forming speed.

In this embodiment, the forming liquid 10 discharged from the forming tank 100 may flow into the liquid collection tank 130 and then transferred to the pressure tank 300 via the pumping line 131 for reuse.

What is claimed is:

1. A three-dimensional printing device, configured for solidifying and forming a forming liquid, comprising:
a forming tank for storing the forming liquid, wherein the bottom of the forming tank protrudes towards the inside of the forming tank to form a forming area;
a pressure tank for providing a predetermined pressure; and
a connecting line, wherein one end of the connecting line is connected to the pressure tank while the other end of the connecting line is connected to the forming tank and is between a top surface of the forming area and the bottom of the forming tank,
wherein the pressure tank provides a predetermined pressure to the forming liquid to make the forming liquid submerge the forming area.

2. The three-dimensional printing device according to claim 1, wherein the forming area is translucent.

3. The three-dimensional printing device according to claim 2, wherein a lighting device is disposed below the forming area.

4. The three-dimensional printing device according to claim 1, wherein the pressure tank stores the forming liquid.

5. The three-dimensional printing device according to claim 4, wherein the pressure tank is connected to an air compressor which is for generating the predetermined pressure.

6. The three-dimensional printing device according to claim 4, wherein the pressure tanks is connected to a liquid storage tank, and a liquid pump for generating the predetermined pressure is disposed between the pressure tank and the liquid storage tank.

7. The three-dimensional printing device according to claim 4, wherein the forming tank forms an overflow wall and a top edge of the overflow wall goes beyond the forming area.

8. The three-dimensional printing device according to claim 7, wherein the forming tank is connected to a liquid collection tank and the overflow wall is between and blocks the forming tank and the liquid collection tank.

9. The three-dimensional printing device according to claim 8, wherein a pumping line is between and connects the pressure tank and the liquid collection tank, and a pumping direction of the pumping line is towards the pressure tank.

10. The three-dimensional printing device according to claim 1, wherein a forming platform is correspondingly arranged on the top of the forming area.
